(19) United States
(12) Patent Application Publication
(10) Pub. No.: US 2015/0278297 A1
(43) Pub. Date: Oct. 1, 2015

(54) METHODS, APPARATUSES AND COMPUTER PROGRAM PRODUCTS FOR PROVIDING A SPEED TABLE FOR ANALYTICAL MODELS

(71) Applicant: CARADIGM USA LLC, BELLEVUE, WA (US)

(72) Inventors: Benjamin Luke Chronister, Woodinville, WA (US); Niranjan Kumar Sharma, Bellevue, WA (US); Sumit Kumar Agarwal, Bellevue, WA (US); Jayakarthik Sabapathy, Bellevue, WA (US); Maruf Md Maniruzzaman Abbasi, Bellevue, WA (US); Jayaram Iyer, Seattle, WA (US); Zhaolong Zhang, Issaquah, WA (US); Peter Burns, Seattle, WA (US); Sudhakar Reddy Kuluru, Bothell, WA (US); Jared Michael Erwin, Redmond, WA (US)

(73) Assignee: CARADIGM USA LLC, BELLEVUE, WA (US)

(21) Appl. No.: 14/229,050

(22) Filed: Mar. 28, 2014

(51) Int. Cl. G06F 17/30

(52) U.S. Cl. CPC G06F 17/30424

(57) ABSTRACT

An apparatus is provided for extending a data model. The apparatus may include at least one memory and at least one processor configured to provide information to a queue responsive to detection of new data associated with a user or an encounter or detection of modified data associated with the user or encounter. The processor is also configured to identify a pattern(s) based on analyzing the information in the queue. The information includes content of the new data or the modified data. The patterns include instructions specifying a calculation(s) for execution based on usage of the new data or the modified data. The processor is also configured to provide results of the calculation(s) to a database to enable access of the results by an application(s) or a communication device(s) responsive to executing a pattern(s) and determining the results of the calculation. Corresponding computer program products and methods are also provided.

### TECHNOLOGICAL FIELD

Embodiments of the invention relate generally to data processing and more particularly relate to a method, apparatus and computer program product for extending data models for usage by applications and providing results of calculations that the applications may access.

### BACKGROUND

Currently, analytics platforms typically require performant extensions of data models without requiring new software releases. At present, many applications require complex query operations which may compute values based on data from many sources, evaluate complex predicates, or require intensive computations. These requirements may make queries of these applications prohibitively expensive to perform during the normal operation of the applications.

For example, consider a query that relates to determining what age bracket a user such as, for example, a patient is within. In this example, the query may ask whether the age of the patient is between 18 and 25, 26 to 35, or 36 to 50. Presume further that several applications (e.g., 50 applications) request this query to be determined such that the age bracket of patients is calculated. In this regard, it may be time consuming and inefficient to process the requests of multiple applications at the same time and determine the age bracket of several patients in a health care system.

In view of the foregoing drawbacks, there may be a need for an efficient and reliable mechanism of providing an extensible framework that efficiently extends data models and provides results of calculations accessible by applications.

### BRIEF SUMMARY

A method, apparatus and computer program product are therefore provided that may provide an efficient and reliable mechanism of extending data models of applications and calculates results that are accessible by applications. In this regard, an example embodiment may calculate results of queries and provide the calculated results to a database (e.g., a speed table of a database) for access by one or more requesting applications or requesting communication devices.

In this regard, an example embodiment may provide an extensible framework for creating and maintaining one or more tables that hold or store the results of calculations corresponding to one or more queries or derivations needed by applications. As such, the framework provided by an example embodiment may provide a reusable parameterized package (e.g., a reusable Extract Transform and Load (ETL) package) describing calculations without requiring a user (e.g., a developer(s)) or application(s) to be concerned about how or when the calculations are executed. The framework of an example embodiment may ensure that the calculations are properly executed per the desires of the user (e.g., a developer(s), an administrator(s), etc.).

In one example embodiment, a method for extending a data model is provided. The method may include providing information to a queue in response to a detection of an indication of new data associated with a user or an encounter or detection of modified data associated with the user or the encounter. The method may further include identifying one or more predefined patterns based in part on analyzing the information in the queue. The information may include content of the new data or the modified data. The patterns may include defined instructions specifying at least one calculation for execution based in part on usage of the content of the new data or the modified data. The method may further include enabling provision of one or more results of the calculation to a database to enable access of the results by one or more requesting applications or one or more requesting communication devices in response to executing at least one of the patterns and determining the results of the calculation.

In another example embodiment, an apparatus for extending a data model is provided. The apparatus may include a processor and a memory including computer program code. The memory and the computer program code are configured to, with the processor, cause the apparatus to at least perform operations including providing information to a queue in response to a detection of an indication of new data associated with a user or an encounter or detection of modified data associated with the user or the encounter. The memory and the computer program code may further cause the apparatus to identify one or more predefined patterns based in part on analyzing the information in the queue. The information may include content of the new data or the modified data. The patterns may include defined instructions specifying at least one calculation for execution based in part on usage of the content of the new data or the modified data. The memory and the computer program code may further cause the apparatus to enable provision of one or more results of the calculation to a database to enable access of the results by one or more requesting applications or one or more requesting communication devices in response to executing at least one of the patterns and determining the results of the calculation.

In another example embodiment, a computer program product for extending a data model is provided. The computer program product includes at least one computer-readable storage medium having computer-executable program code instructions stored therein. The computer executable program code instructions may include program code instructions configured to provide information to a queue in response to a detection of an indication of new data associated with a user or an encounter or detection of modified data associated with the user or the encounter. The program code instructions may also identify one or more predefined patterns based in part on analyzing the information in the queue. The information may include content of the new data or the modified data. The patterns may include defined instructions specifying at least one calculation for execution based in part on usage of the content of the new data or the modified data. The program code instructions may also enable provision of one or more results of the calculation to a database to enable access of the results by one or more requesting applications or one or more requesting communication devices in response to executing at least one of the patterns and determining the results of the calculation.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a communication device according to an exemplary embodiment of the invention;

FIG. 3 is a schematic block diagram of a computing device according to an exemplary embodiment of the invention; and

FIG. 4 is a flowchart of an exemplary method according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

General System Architecture

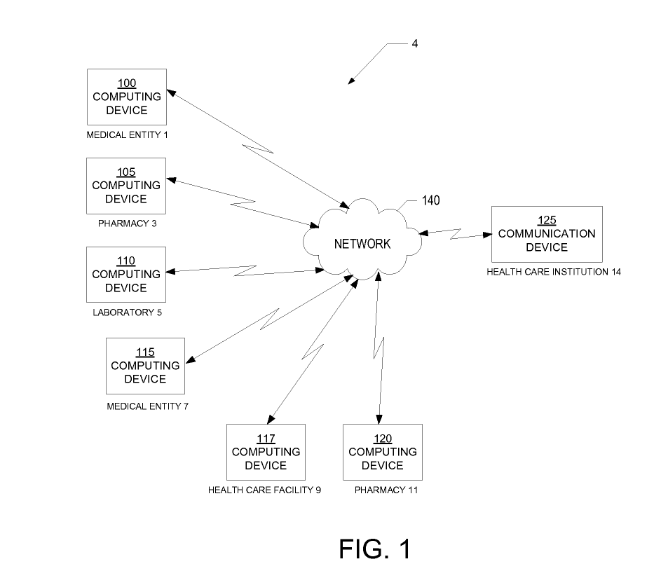

Referring now to FIG. 1, a block diagram of a system according to an exemplary embodiment is provided. As shown in FIG. 1, the system 4 (e.g., a health care system 4) may include one or more computing devices 100, 105, 110, 115, 117 and 120 (e.g., personal computers, laptops, tablet computing devices, workstations, servers, personal digital assistants, smart devices and the like, etc.) which may access one or more network entities such as, for example, a communication device 125 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 125 is capable of receiving data from and transmitting data to the computing devices 100, 105, 110, 115, 117 and 120 via network 140.

In one exemplary embodiment, the computing devices 100, 105, 110, 115, 117 and 120 may be utilized by users such as, for example, clinicians (e.g., physicians, nurses, pharmacists, psychologists, social workers, physical therapists, laboratory technicians, etc.) and/or any other suitable health care professionals. The computing devices 100, 105, 110, 115, 117, 120 may be maintained by one or more health care institutions. For instance, the computing device 100 may be maintained by a medical entity 1 (e.g., a medical clinic), the computing device 105 may be maintained by a pharmacy 3, the computing device 110 may be maintained by a laboratory 5. In addition, the computing device 115 may be maintained by a medical entity 7 (e.g., a hospital), the computing device 117 may be maintained by a health care facility 9 (e.g., a psychotherapy entity (e.g., a psychiatric office, an office of a social worker, etc.) and the computing device 120 may be maintained by the pharmacy 11. In an exemplary embodiment, the communication device 125 may be maintained by a health care institution 14. The communication device 125 may be utilized by one or more users (e.g., clinicians).

The communication device 125 may communicate with the computing devices 100, 105, 110, 115, 117, and 120. In this regard, the communication device 125 may receive one or more requests or queries from computing devices 100, 105, 110, 115, 117, and 120 or applications (e.g., health applications, billing applications, etc.) of computing devices 100, 105, 110, 115, 117, and 120. The requests/queries may include data requesting one or more calculations. The communication device 125 may also receive information ( ) from and may transmit medical information to the computing devices 100, 105, 110, 115, 117, and 120.

It should be pointed out that although FIG. 1 shows six computing devices 100, 105, 110, 115, 117, 120 and one communication device 125 any suitable number of computing devices 100, 105, 110, 115, 117, 120 and communication devices 125 may be part of the system of FIG. 1 without departing from the spirit and scope of the invention.

### Communication Device

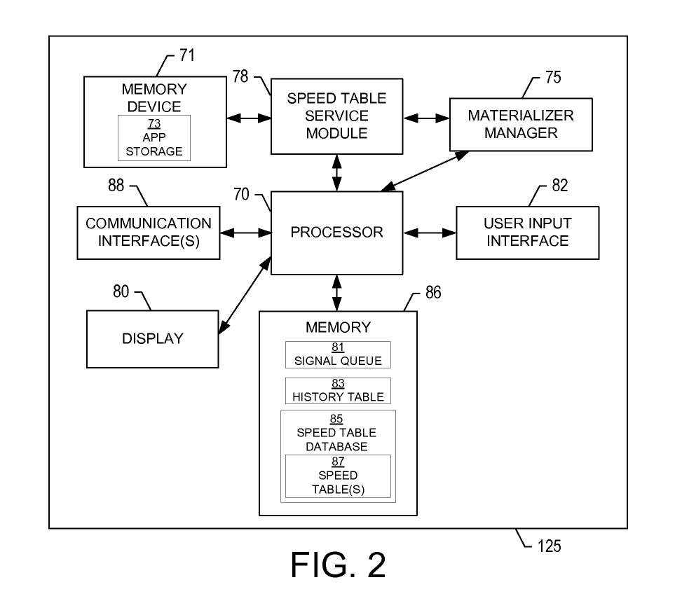

Referring now to FIG. 2, a block diagram of a communication device is provided according to an exemplary embodiment of the invention. The communication device 125 may, but need not, be a network device such as, for example, a server. The communication device 125 may include various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 125 may include a processor 70 connected to a memory 86 (also referred to herein as database 86). The memory 86 may comprise volatile and/or non-volatile memory, and typically stores content (e.g., media content, medical information, etc.), data, information or the like.

For example, the memory 86 may store content transmitted from, and/or received by, the computing devices 100, 105, 110, 115, 117 and 120. In this regard, in an exemplary embodiment, the memory 86 may store data received from various disparate sources. For example, the memory 86 may store medical information received by the communication device 125 from the computing devices of the medical entity 1, the pharmacy 3, the laboratory 5, the medical entity 7, the health care facility 9 and the pharmacy 11, etc. The medical information may include, but is not limited to, prescriptions, visits to a health care facility, medications, medical diagnoses, laboratory results, medical tests or measurements, medical chart information, medical imaging information (e.g., magnetic resonance imaging (MRI) of the human body), alert/notification data and any other suitable information.

The medical information received by the communication device 125 from the computing devices 100, 105, 110, 115, 117, 120 may include one or more patient identifiers of respective patients. For example, medical record numbers (MRNs) may be utilized as patient identifiers to identify respective patients. In addition, or alternatively, patient demographic data (e.g., biographical data (e.g., name, date of birth, etc.), race, age, gender, etc.) may be utilized to identify one or more patients. These patient identifiers and patient demographic data may be stored in the memory 86 (e.g., in a history table 83 of the memory 86).

Additionally, for example, the memory 86 typically stores client applications, instructions, patterns, keys, algorithms or the like for execution by the processor 70 to perform steps associated with operation of the communication device 125 in accordance with embodiments of the invention. The patterns may include logic (e.g., software code (e.g., computer code/instructions)) to perform derivations or calculations when executed (e.g., by a processor (e.g., processor 70) and/or a speed table service module (e.g., speed table service module 78)) and may include metadata corresponding to the logic, as described more fully below. As explained below, for example, the memory 86 may store one or more client applications such as, for example, software (e.g., software code also referred to herein as computer code). The memory 86 may include a queue (e.g., signal queue 81), a history table 83 and a speed table database 85 that includes one or more speed tables 87. As data (e.g., source data) changes, the materializer manager 75 may generate signals that are provided to the signal queue 81 (e.g., a Structured Query Language (SQL) signal queue) which may be read by the speed table service module, as described more fully below.

The one or more speed tables 87 (also referred to herein as one or more speed table entities 87 or as speed table(s) 87) may be the destination for data generated by the speed table service module 78 and any application(s) may read from the one or more speed tables 87. However, the speed table service module 78 may write to the one or more speed tables 87. In an example embodiment, the speed table service module 78 may manage the properties and/or functions of the one or more speed tables 87, as described more fully below. The history table 83 may store data (e.g., medical data) associated with one or more patients (e.g., lab results of corresponding patients, number of visits to a health care facility, etc.). In addition, the history table 83 may store one or more patient identifiers corresponding to the patients. In some example embodiments, the patient identifiers may be analyzed by the speed table service module 78 to merge data (e.g., medical data) corresponding to a patient, as described more fully below.

The speed table service module 78 may poll (e.g., periodically polls) the signal queue 81 which the materializer manager 75 may write data (e.g., newly received patient data (e.g., new lab results, new information indicating visits to a health care facility)) to and as the data is read from the signal queue 81, the speed table service module 78 may delete the read data from the signal queue 81. However, the speed table service module 78 may include the read data in an application (app) storage 73 (also referred to herein as local app storage 73 or app storage 73) of a memory device 71, as described more fully below.

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 125 may include one or more logic elements for performing various functions of one or more client applications. In an exemplary embodiment, the communication device 125 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, computing devices 100, 105, 110, 115, 117, 120 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface may support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control the materializer manager 75. The materializer manager 75 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the materializer manager 75, as described below. In examples in which software is employed, a device or circuitry (e.g., processor 70 in one example) executing the software forms the structure associated with such means. As such, for example, the materializer manager 75 may be configured to, among other things, to detect one or more modifications of data and/or newly received data (e.g., received from one or more of computing devices 100, 105, 110, 115, 117, 120), stored in a database (e.g., database 86), corresponding to one or more patients. In response to detecting one or more items of modified data (e.g., medical data) or new data corresponding to a patient(s), the materializer manager 75 may write or provide an indication of the modified data or new data (e.g., new lab results, an updated number of visits to a health care facility) to a signal queue (e.g., signal queue 81) for detection by the speed table service module 78, as described more fully below.

Additionally, in an example embodiment, the processor 70 may be in communication with and may otherwise control the speed table service module 78. The speed table service module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the speed table service module 78, as described below. In examples in which software is employed, a device or circuitry (e.g., processor 70 in one example) executing the software forms the structure associated with such means. As such, for example, the speed table service module 78 may be configured to, among other things, periodically poll the signal queue 81 indicating the modified data or new data corresponding to one or more patients (e.g., Jane Doe, a fictitious person as referred to herein), written/provided to the signal queue 81 by the materializer manager 75.

In an example embodiment, the speed table service module 78 may perform one or more calculations (e.g., calculate all visits of a patient to a health care facility, etc.) defined by a pattern (e.g., logic (e.g., defined computer program code for performing the calculation(s)) associated with a corresponding key, as described more fully below. The speed table service module 78 may provide the results of the calculation(s) to the speed table(s) 87 of the speed table database 85 to enable one or more requesting applications (e.g., health care applications, billing applications, etc.) or devices (e.g., computing devices 100, 105, 110, 115, 117, 120) hosting the applications to access/obtain the results of the calculations, as described more fully below.

### Computing Device

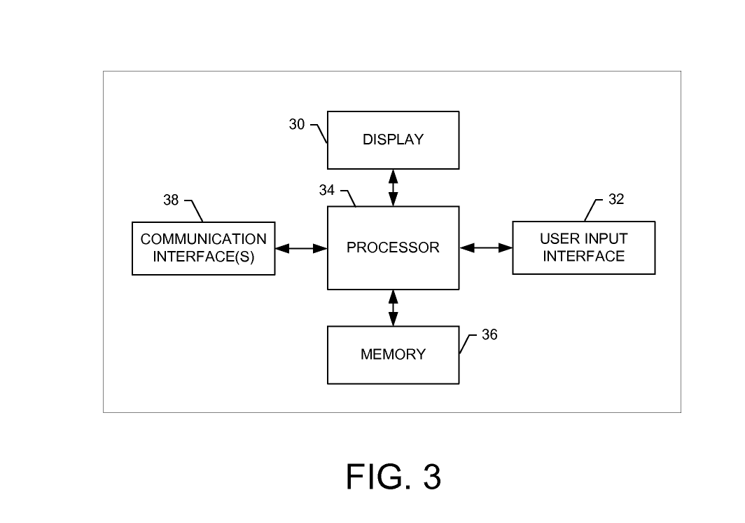

Referring now to FIG. 3, a block diagram of a computing device according to an exemplary embodiment is provided. The computing device is capable of operating as any of computing devices 100, 105, 110, 115, 117 and 120. In this regard, the computing devices 100, 105, 110, 115, 117, and 120 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. In addition, the memory device 36 may store client applications (e.g., health care applications, billing applications, etc.), software (e.g., software code) algorithms, instructions or the like for the processor 34 to perform steps associated with operation of the computing device.

The memory device 36 may store medical information (e.g., medical diagnoses, laboratory results, medications, prescriptions, medical visit information, etc.) associated with one or more patients. The medical information may include one or more patient identifiers (e.g., MRNs) identifying respective patients (e.g., Jane Doe, a fictitious patient) and/or biographic data.

In an instance in which medical information (e.g., new medical data, updates and/or changes to medical data) of one or more of the patients is sent to the communication device 125, by the processor 34, the materializer manager 75 of the communication device 125 may detect a patient identifier(s) (e.g., a MRN(s), biographic data, etc.) to identify respective patients and corresponding medical data. In this manner, the materializer manager 75 may detect data received from various sources/entities (e.g., medical entities, pharmacies, laboratories health care facilities, etc.) pertaining to one or more patients.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display or any other input device. In an example embodiment, in response to being executed by processor 34 one or more applications (e.g., health care applications, billing applications, etc.), stored in the memory 36, may send a request(s) for one or more results of calculations to the communication device 125, as described more fully below.

### Exemplary System Operation

Exemplary embodiments of the invention may provide an efficient and reliable mechanism for extending data models of applications. In this regard, an exemplary embodiment may calculate results of queries or other derivations (e.g., defined by one or more patterns) and provide the calculated results to a table (e.g., a speed table) of a database (e.g., a speed table database) for access (e.g., fast access) by one or more requesting applications. As such, an exemplary embodiment may enable multiple applications to access or obtain the calculated results from the table (e.g., speed table(s) 87) based on calculations that were previously performed in response to detecting data (e.g., newly received medical data, updates/changes to medical data (e.g., changes to existing medical data)) associated with one or more patients, as described more fully below.

In this manner, an example embodiment may provide an extensible framework for creating and maintaining one or more tables that hold or store the results of calculations in response to one or more queries for access by one or more requesting applications or requesting communication devices. As such, the framework provided by an example embodiment may enable developers to provide a reusable package (e.g., a reusable ETL package) describing calculations of the queries without requiring a user (e.g., a developer(s)) to be concerned about the manner in which the calculations are executed. The framework of an example embodiment may ensure that the calculations are properly executed per the desires of a user (e.g., a developer(s), an administrator(s), etc.).

By utilizing an example embodiment, extensible analytical models may be driven by content. For instance, an example embodiment may enable a data model to grow based upon determined calculations (e.g., number of visits by a patient to a health care facility, new lab results for a patient). The data model may be extended automatically in order to incorporate a new element(s) of information (e.g., a result for a new type of lab test). In this regard, the data model may include one or more tables which include rows and columns of information, wherein each column represents a new type of calculation, and each row represents one instance of each of the calculations which corresponds to a specific patient or encounter or other keyed value. For example, in an instance in which results of calculations are determined by the speed table service module 78, the results of the calculations may be output to a memory (e.g., a speed table(s) 87 of a speed table database 85) and as such the results of these calculations may be new items of information that may be added to the data model without altering or destroying the underlying data model. In this regard, new items of information may be added to the data model automatically and as such the data model may be extended.

Furthermore, generalized analytical computations driven by content may be obtained by utilizing an example embodiment. For instance, calculations may be automatically determined by the speed table service module 78 in an instance in which new or updated data is detected (e.g., detection of another visit to a health care facility by patient Jane Doe) corresponding to a patient or an encounter that is relevant to one or more queries (e.g., a query specifying calculation of a count or number of all visits by patients to the health care facility) received from an application(s) or a device (e.g., computing device 115).

Moreover, by utilizing an example embodiment, normalization of computation of similar derivations is provided. In an example embodiment, normalization of computation of similar derivations may involve a calculation defined to be performed but which is parameterized such that the calculation may be performed in many different ways. For purposes of illustration and not of limitation, suppose patient Jane Doe visits a hospital and a user (e.g., a developer) desires a calculation of patient Jane Doe's latest blood test(s). Suppose further that patient Jane Doe recently had a blood test and a user (e.g., a developer, etc.) always wants to know the most recent results of the blood test. In this regard, a calculation may be defined, via processor 70, to calculate the latest blood test results of patient Jane Doe. Moreover, the calculation may be defined such that the calculation is driven by content specifying that the latest glucose, the latest white blood cell count, the latest blood gases results, etc. are determined. In this example, a generalized normalization calculation/computation may be defined as latest lab results that are parameterized and driven by specific contents of lab results such as, for example, latest glucose, the latest white blood cell count, and/or latest blood gases results.

In an example embodiment, the speed table service module 78 may execute one or more defined patterns in response to detecting information written to the signal queue 81 by the materializer manager 75. The patterns may include all the logic (e.g., computer code, computer instructions) to perform a derivation(s) or calculation(s) (e.g., “LatestResults” (e.g., calculate the latest lab results of a patient (e.g., Jane Doe)) designated to be performed. The patterns may also include metadata about the calculation(s). The metadata may include, but is not limited to: (1) a unique identifier that is constant across environments; (2) a name; (3) a version number; (4) a subject entity (e.g., an object that the result of the calculation(s) is about (e.g., a person or an encounter) (e.g., in an instance in which the calculation is about a person, the subject entity may be “Person” or in an instance in which the calculation is about a particular visit or encounter, the subject entity may be “Encounter”, or in the case when the calculation is about any other entity this other entity may be specified as the subject entity)); (5) a set of source entities the pattern(s) uses to perform the calculation(s) (e.g., the result of the most recent lab test may make use of the Encounter, Result, and/or Order entities to perform the calculation) where the source entities are related to the subject entity by means of a foreign key relationship; (6) a set of parameters; (7) a set of outputs; (8) a target speed table entity; (9) an algorithm (e.g., logic (e.g., computer code, computer instructions)) for performing the calculation(s); or (10) any other suitable metadata. The patterns may be stored in in a database (e.g., database 86) of a health care system (e.g., health care system 4). As referred to herein, an entity, or source entity may be defined as a collection of information related to a single concept and may be embodied as a table(s) of information in a database wherein each instance(s) (or row(s)) of such related information includes multiple properties (or columns) and the instance(s) may be referenced by a unique key.

By indicating the source entities in the metadata of a pattern(s), the speed table service module 78 may analyze the indications of the source entities to determine where the source data is stored (e.g., database 86) for performing a calculation(s) and to enable the materializer manager 75 to track changes in the source data and perform the calculation(s) again at an appropriate time.

The speed table service module 78 may also analyze a key(s) associated with a pattern(s). For example, a key(s) may be an instance(s) of a pattern(s) applied to a specific situation. In this regard, the speed table service module 78 may enable implementation by using a general use pattern and make the general use pattern specific for a given set of data and/or a given set of desired outputs. In this manner, a normalized pattern/algorithm (e.g., latest lab results) may be applied across specific data (e.g., latest glucose results, latest white blood cell count results, the latest blood gases results).

In an example embodiment, keys may serve as callers of corresponding patterns. For instance, the speed table service module 78 may use a key to call or retrieve a corresponding pattern for execution. An example of a key for a “LatestResults” pattern may be “LatestHBA1C”. Each key may include, but is not limited to, a unique identifier that is constant across environments, a name, a set of parameter values for the key corresponding to inputs for a pattern(s), a status flag, a status reason comment, or any other suitable data. The keys may be stored, in memory (e.g., database 86), as separate metadata related to a corresponding pattern object. In an example embodiment, although the keys may be stored as separate metadata from the corresponding pattern object, the keys may be linked to corresponding patterns.

The parameter values of the key may alter the execution of a corresponding pattern for each key. For example, in an instance in which a key is created for latest glucose results, an International Statistical Classification of Diseases (ICD)-9 code for a glucose test may be included in the parameter values. In this example, in an instance in which the speed table service module 78 may execute the corresponding pattern, the speed table service module 78 may detect glucose values.

The speed table service module 78 may provide generated data (e.g., calculated results) to one or more speed table entities (e.g., speed table(s) 87). In other words, the speed table entities may be the destination for data generated by the speed table service module 78. In an example embodiment, any application(s) may read/retrieve data from the speed table entities (e.g., speed table(s) 87) but the application(s) may be unable to provide or write data to the speed table entities. Instead, the speed table service module 78 may be able to write or provide data to the speed table entities. The speed table service module 78 may handle the management and functions (e.g., administrative functions) of the speed table entities (e.g., speed table(s) 87).

In an example embodiment, the speed table entities may serve as the location in which data is added to a data model (e.g., which extends the data model). In other words, for a created data model, new properties, and/or new items of data may be included in a speed table entity (e.g., speed table(s) 87). For example, when a pattern is initially created one of the items of metadata of the pattern is specified as a target speed table entity, as described above. Suppose, for example, that a new pattern “Latest Results” is being defined for the first time. In this regard, in an instance in which corresponding keys are added/linked to the latest results pattern such as, for example, a key for glucose, a key for white blood cell counts and/or a key for blood gases, the new pattern “Latest Results” may begin to have new properties. In this manner, the latest glucose value, the latest glucose observation date and time, the latest glucose unit, the latest white blood cell count value, the latest white blood cell count units, etc. may be included in a speed table entity (e.g., speed table(s) 87) and added to a data model for the pattern “Latest Results” which may be read or accessed by any application(s) (e.g., a health care application(s), a billing application(s), etc.).

The speed table service module 78 may poll (e.g., periodically poll) a queue (e.g., a SQL queue (e.g., signal queue 81)) in which the materializer manager 75 may write or provide data. As data is read or accessed from the queue (e.g., signal queue 81), the speed table service module 78 may delete the read/accessed data from the queue and the speed table service module 78 may provide the data read/accessed from the queue to a local storage (e.g., application (app) storage 73) of a memory 71 until the data is successfully processed.

As changes are made to source data (e.g., stored in memory 86), the materializer manager 75 may detect the changes to the source data (also referred to herein as changed sets of data) and may generate one or more signals which are provided to a queue (e.g., SQL queue (e.g., signal queue 81)). As described above, the speed table service module 78 may read the data (e.g., changed sets of data) from the queue (e.g., signal queue 81). In this regard, in response to detecting that the source data is being modified or updated based on reading the data (e.g., changed sets of data) from the queue, the speed table service module 78 may perform a calculation(s) of a corresponding pattern associated with a key(s) for a corresponding patient(s) or encounter(s) in an instance in which the pattern depends on the source data. For example, in an instance in which a calculation has been defined to pre-calculate the latest Glucose lab test result, whenever the speed table service module 78 is notified that a new lab result has arrived, a calculation may be performed to determine whether the result is for a Glucose test and if the result is for a Glucose test, the latest value previously stored may need to be updated. The calculation(s) may be performed/determined by the speed table service module 78 based in part on the parameter(s) associated with the key(s).

For purposes of illustration and not of limitation consider an example in which a patient such as, for example, Jane Smith (e.g., a fictitious patient) has been in a health care facility such as, for example, a hospital several times. Since patient Jane Smith has been in the hospital several times, the speed table service module 78 may have previously detected data about patient Jane Smith. In this example, presume that patient Jane Smith is currently admitted to the emergency room of the hospital and that patient Jane Smith is unconscious. As such, data for a new patient such as Jane Doe (e.g., a placeholder patient name) may be entered and stored (e.g., stored in a memory (e.g., memory 86)) in a health care system (e.g., health care system 4) since health care professionals (e.g., nurses, doctors) by convention use this name to indicate she is an unknown patient. However, the patient is presently unconscious and is unable to confirm her identity.

Presume further that the health care professionals (e.g., doctors, nurses) do not know what is wrong with patient Jane Doe and as such the health care professionals begin performing some lab results on her to obtain some lab results. In response to the materializer manager 75 detecting that Jane Doe is a new patient, the materializer manager 75 may send a signal(s) indicating detection of new patient Jane Doe to a queue (e.g., signal queue 81).

In response to polling the queue (e.g., signal queue 81), the speed table service module 78 may detect the signal(s) provided to the queue by the materializer manager 75 and may specify that the data relates to a new visit and/or a common encounter. As such, the speed table service module 78 may run/execute an admission statistics package or a calculation for a common encounter pattern to update data for new patient Jane Doe in this example. In response to running/executing the admission statistics package, the speed table service module 78 may identify one or more patterns that are concerned about common encounter data and that are specified to calculate admission statistics.

In this regard, the speed table service module 78 may calculate the number of visits over the course of the year for Jane Doe which is one new patient visit in this example. The speed table service module 78 may write or provide the results of the calculation pertaining to the number of visits to the speed table(s) 87 of a speed table database 85.

Subsequently, the materializer manager 75 may write or provide, via a new signal(s), the lab results indicating, for example, glucose and white blood cells count and/or blood gases to the queue (e.g., signal queue 81). In this regard, the signal(s) provided to the queue (e.g., signal queue 81) by the materializer manager 75 may indicate that the data is common results and that the data is for Jane Doe. In an example embodiment, in response to reading the data from the queue (e.g., signal queue 81), the speed table service module 78 may delete the data from the queue and include the read/accessed data in a local storage (e.g., app storage 73 of memory device 71) until the data is successfully processed.

Additionally, in response to detecting the signal(s) in the queue (e.g., signal queue 81), the speed table service module 78 may send a notification to a latest results package for patterns specifying information about common results and in this regard the speed table service module 78 may calculate the latest blood glucose, the latest white blood cell count, etc. based on the lab results for Jane Doe. As such, the speed table service module 78 may write or provide the results (e.g., values) of the calculation(s) of the common results to speed table(s) 87.

In this example, presume further that the patient referred to as Jane Doe wakes up the next morning from being admitted to the emergency room of the hospital and informs the health care professionals (e.g., doctors, nurses) that her name is Jane Smith. In response to correcting the name of the patient to Jane Smith, the health care professionals, for example, may determine that there are prior entries related to this same patient, Jane Smith, in a database (e.g., memory 86) of the health care system (e.g., health care system 4) and may instruct the health care system to perform a merge operation. As such, the processor 70 and/or the speed table service module 78 may receive a message indicating that the processor 70 and/or the speed table service module 78 should merge the set of data associated with Jane Doe with the set of data stored for Jane Smith. Since Jane Smith has visited this hospital multiple times in the past, prior data associated with Jane Smith may be stored in the history table 83 of a memory (e.g., memory 86). The history table 83 may store patient identifiers of all patients in which the health care system (e.g., health care system 4) stores data.

The speed table service module 78 may poll (e.g., periodically poll) the history table 83 to detect changes. In this regard, the speed table service module 78 may detect the changes associated with the merged data which now corresponds to patient Jane Smith. As such, the speed table service module 78 may determine that recalculation of data associated with Jane Smith may be required since new data (e.g., data pertaining to Jane Doe) was merged with the stored data for Jane Smith.

As such, the speed table service module 78 may run multiple patterns and perform various corresponding calculations across multiple source entities since Jane Smith may have data across multiple source entities and not just data for common results or new visit data as was the case for patient Jane Doe. In this manner, the speed table service module 78 may calculate all of Jane Smith's visits in the last year and may calculate all of her latest lab results as well as perform other calculations since Jane Smith may have data across various source entities. In this regard, the speed table service 78 may respond appropriately to patient(s) merge events.

The speed table service module 78 may provide the results of the calculations pertaining to the merged data across multiple source entities to the speed table(s) 87 of the speed table database 85. Once the results of the calculations are provided to the speed table(s) 87, one or more applications (e.g., 1 application, 10 applications, 100 applications, etc.) may read or access the calculated results and may utilize the results without performing the calculations themselves since the results are already calculated by the speed table service module 78. In this regard, the speed table service module 78 may enhance efficiencies and perform calculations faster as data associated with a patient(s) or encounter(s) is received and detected.

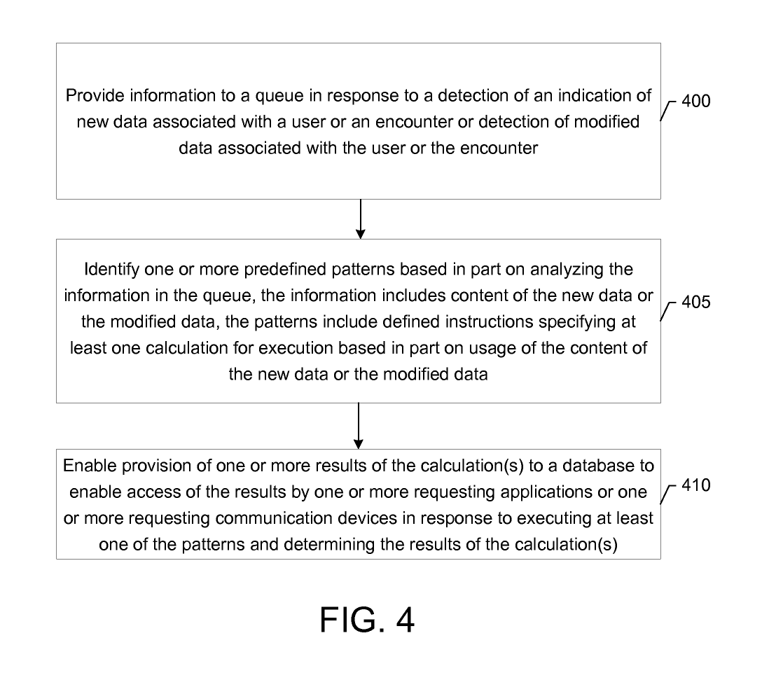

Referring now to FIG. 4, an exemplary method for extending a data model according to an exemplary embodiment is provided. At operation 400, an apparatus (e.g., communication device 125) may provide information to a queue (e.g., signal queue 81) in response to a detection of an indication of new data (e.g., new lab results or admission data for a new patient, etc.) associated with a user (e.g., patient John Doe, fictitious patient) or an encounter (e.g., a visit(s) to a health care facility, etc.) or detection of modified data (e.g., data updated from stored existing data (e.g., stored in history table 83)) corresponding to a patient and newly received information corresponding to the patient (e.g., Jane Doe)) associated with the user or the encounter. At operation 405, the apparatus (e.g., communication device 125) may identify one or more predefined patterns (e.g., computer instructions for performing a calculation(s)) based in part on analyzing the information (e.g., a signal(s) indicating data) in the queue (e.g., signal queue 81). The information may include content of the new data or the modified data. The patterns may include, but are not limited to, defined instructions specifying at least one calculation (e.g., calculate the latest lab results of a patient(s)) for execution based in part on usage of the content of the new data or the modified data (e.g., calculate the number of visits to a health care facility during the year by detecting existing visit information and using the information indicating a current new visit to the health care facility).

At operation 410, the apparatus (e.g., communication device 125) may enable provision of one or more results of the calculation to a database (e.g., speed table database 85) or a table (e.g., speed table(s) 87) of the database (e.g., speed table database 85) to enable access of the results by one or more requesting applications (e.g., health care applications, billing applications, etc.) or one or more requesting communication devices (e.g., computing devices 100, 105, 110, 115, 117 and/or 120) in response to executing at least one of the patterns and determining the results of the calculation.

It should be pointed out that FIG. 4 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86) and executed by a processor (e.g., processor 70, speed table service module 78, materializer manager 75). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 4 above may comprise a processor (e.g., the processor 70, the speed table service module 78, the materializer manager 75) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70 (e.g., as means for performing any of the operations described above), the speed table service module 78, the materializer manager 75 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
providing information to a queue in response to a detection of an indication of new data associated with a subject or an encounter or detection of modified data associated with the subject, the information comprising content of the new data or the modified data;
accessing one or more patterns, each pattern specifying both (1) one or more pieces of source information for a subject and (2) a calculation to perform on the values of the specified pieces of source information for the subject to obtain a result value for the subject;
with the processor, identifying information in the queue that matches at least one piece of source information specified by a distinguished pattern;
in response to the identifying, performing the calculation specified by the distinguished pattern against information about the subject including the identified information in the queue to obtain a result value; and
enabling provision of the result of the calculation to a database to enable access of the results by one or more requesting applications or one or more requesting communication devices in response to performing the calculation.

2. The method of claim 1, wherein analyzing the queue further comprises retrieving the information from the queue in response to periodically polling the queue to detect the information.

3. The method of claim 1, wherein enabling provision further comprises enabling provision of the results of the calculation to a table which enables the applications or the communication devices to obtain the results of the calculation in response to receipt of at least one query from the applications or the communication devices requesting the results.

4. The method of claim 1, wherein executing further comprises retrieving at least one key corresponding to the at least one pattern, the key comprises data indicating that the calculation is specific for designated or assigned data.

5. The method of claim 1, wherein prior to providing the information, the method further comprises:
defining the patterns to comprise the defined instructions specifying the at least one calculation and an indication of a subject entity in which the calculation is designated for performance.

6. The method of claim 1, wherein:
the information comprises medical information;
the subject comprises a patient; and
the one or more applications comprise one or more health care applications.

7. The method of claim 1, wherein prior to identifying, the method further comprises:
deleting the information from the queue in response to reading the information from the queue; and
enabling provision of the information to a memory for storage until detection of an indication that the information is properly processed.

8. The method of claim 1, further comprising:
utilizing the results and the content of the new data or the modified data, in part, to extend a data model to enable the results and content to be utilized in response to subsequently executing the at least one pattern.

9. The method of claim 1, further comprising:
restricting the requesting applications or the requesting communication devices from providing or storing data to the database that enables access of the results of the calculation.

10. An apparatus comprising at least one processor and at least one memory including computer program code, the at least one memory and the computer program code configured to, with the processor, cause the apparatus to at least:
provide information to a queue in response to a detection of an indication of new data associated with a subject or an encounter or detection of modified data associated with the subject or the encounter, the information comprising content of the new data or the modified data;
accessing one or more patterns, each pattern specifying both (1) one or more pieces of source information for a subject and (2) a calculation to perform on the values of the specified pieces of source information for a subject to obtain a result value for the subject;
with the processor, identifying information in the queue that matches at least one piece of source information specified by a distinguished pattern;
in response to the identifying, performing the calculation specified by the distinguished pattern against information about the subject including the identified information in the queue to obtain a result value; and
enable provision of the result of the calculation to the database to enable access of the result of the questing applications or one or more requesting communication devices in response to performing the calculation.

11. The apparatus of claim 10, wherein the memory and computer program code are further configured to, with the processor, cause the apparatus to:
analyze the queue by retrieving the information from the queue in response to periodically polling the queue to detect the information.

12. The apparatus of claim 10, wherein the memory and computer program code are further configured to, with the processor, cause the apparatus to:
enable provision by enabling provision of the results of the calculation to a table which enables the applications or the communication devices to obtain the results of the calculation in response to receipt of at least one query from the applications or the communication devices requesting the results.

13. The apparatus of claim 10, wherein the memory and computer program code are further configured to, with the processor, cause the apparatus to:
perform the calculation based in part on retrieving at least one key corresponding to the at least one pattern, the key comprises data indicating that the calculation is specific for designated or assigned data.

14. The apparatus of claim 10, wherein prior to provide the information, the memory and computer program code are further configured to, with the processor, cause the apparatus to:
define the patterns to comprise the defined instructions specifying the at least one calculation and an indication of a subject entity in which the calculation is designated for performance.

15. The apparatus of claim 10, wherein:
the information comprises medical information;
the subject comprises a patient; and
the one or more applications comprise one or more health care applications.

16. The apparatus of claim 10, wherein prior to identify, the memory and computer program code are further configured to, with the processor, cause the apparatus to:
delete the information from the queue in response to reading the information from the queue; and
enable provision of the information to a memory for storage until detection of an indication that the information is properly processed.

17. The apparatus of claim 10, wherein the memory and computer program code are further configured to, with the processor, cause the apparatus to:
utilize the results and the content of the new data or the modified data, in part, to extend a data model to enable the results and content to be utilized in response to subsequently executing the at least one pattern.

18. The apparatus of claim 10, wherein the memory and computer program code are further configured to, with the processor, cause the apparatus to:
restrict the requesting applications or the requesting communication devices from providing or storing data to the database that enables access of the results of the calculation.

19. A computer program product comprising at least one non-transitory computer-readable storage medium having computer-executable program code instructions stored therein, the computer executable program code instructions comprising:
program code instructions configured to provide information to a queue in response to a detection of an indication of new data associated with a subject or an encounter or detection of modified data associated with the subject or the encounter, the information comprising content of the new data or the modified data;
accessing one or more patterns, each pattern specifying both (1) one or more pieces of source information for a subject and (2) a calculation to perform on the values of the specified pieces of source information for a subject to obtain a result value for the subject;
with the processor, identifying information in the queue that matches at least one piece of source information specified by a distinguished pattern;
in response to the identifying, performing the calculation specified by the distinguished pattern against information about the subject including the identified information in the queue to obtain a result value; and
program code instructions configured to enable provision of the result of the calculation to a database to enable access of the results by one or more requesting applications or one or more requesting communication devices in response to performing the calculation.

20. The computer program product of claim 19, further comprising:
program code instructions configured to analyze the queue by retrieving the information from the queue in response to periodically polling the queue to detect the information.

21. One or more instances of computer-readable media collectively storing a speed table data structure, the data structure comprising:
for each of a plurality of application programs:
a set of entries corresponding to a formula specified in connection with the application program for deriving a result value from one or more patient information values of a patient, the set of entries comprising, for each of a plurality of patients, an entry containing a result value derived from patient information values for the patient using the formula to which the set of entries corresponds.

22. The instances of computer-readable media of claim 21 wherein a distinguished entry was updated in response to detecting a new patient information value for the patient to whom the distinguished entry corresponds.

23. One or more instances of computer-readable media collectively storing a speed table data structure, the data structure comprising:
a first entry containing a first value derived from health data about a first patient, the first entry available for access by a first application; and
a second entry containing a second value derived from health data about the first patient, the second value being distinct from the first value, the second entry available for access by a second application.

24. The instances of computer-readable media of claim 23 wherein the second application is distinct from the first application.

25. The instances of computer-readable media of claim 23 wherein the first value was calculated based upon a formula specified by the first application.

26. The instances of computer-readable media of claim 23 wherein second entry is also available for access by the first application.

27. One or more instances of computer-readable media collectively having contents configured to cause a computing system to perform a method for extending a speed table shared by applications, the method comprising:
in connection with an application, receiving a pattern specifying (1) one or more pieces of source information for a patient, (2) a calculation to perform on values of the specified pieces of source information to obtain a result value for the patient; and
in response to the receiving, storing the pattern for application to information about each of a plurality of patients.

28. The more instances of computer-readable media of claim 27, further comprising allocating a speed table column for storage of results for the plurality of patients in accordance with the distinguished formula.

29. The more instances of computer-readable media of claim 27, further comprising allocating a speed table for storage of results for the plurality of patients in accordance with the distinguished formula.
